(19) United States
(12) Patent Application Publication
(10) Pub. No.: US 2014/0347576 A1
(43) Pub. Date: Nov. 27, 2014

(54) DISPLAY DEVICE

(71) Applicant: Samsung Display Co., Ltd., Yongin-city (KR)

(72) Inventors: Chul-Woo Jeong, Yongin-city (KR); Soon-Ryong Park, Yongin-city (KR); Seok-Gi Baek, Yongin-city (KR); Jung-Ho So, Yongin-city (KR); Tae-Eun Kim, Yongin-city (KR)

(73) Assignee: Samsung Display Co., Ltd., Yongin-city (KR)

(21) Appl. No.: 14/030,507

(22) Filed: Sep. 18, 2013

(30) Foreign Application Priority Data
May 21, 2013 (KR) 10-2013-0057251

(51) Int. Cl. G06F 1/16

(52) U.S. Cl. CPC G06F 1/1601
USPC 349/12; 428/532; 428/523; 428/522; 428/412; 428/480; 428/216

(57) ABSTRACT

In an aspect, a display device including a display panel, a first protecting film attached under the display panel, and a second protecting film attached on the second protecting film, in which at least any one of the first and second protecting films includes a retardation layer is provided.

### INCORPORATION BY REFERENCE TO RELATED APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0057251 filed in the Korean Intellectual Property Office on May 21, 2013, the disclosure of which is incorporated herein by reference in its entirety.

### BACKGROUND

1. Field

The present disclosure relates to a display device.

2. Description of the Related Technology

A display device consists of a polarizing plate, a touch panel, and a window, which are stacked above a display panel.

When a polyimide (PI) layer is included in the display panel and has a thickness of about 20˜50 μm, it is vulnerable to physical impact and likely to have heavy curves.

Accordingly, a protecting film may be on the PI layer. However, when a polyethylene terephthalate (PET) film is used as the protecting film there is a problem in which a mechanical strength thereof is very weak during bending.

The PET film needs to be formed very thickly in order to improve physical reliability thereof.

However, when the PET film is formed very thickly, the PET film does not bend well and the mechanical strength thereof is not vey good, which may cause many faults in the display panel.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a display device having advantages of having a simplified structure and minimizing stress applied at the time of bending, by using a protecting film having a thin thickness, superior mechanical strength, and no distortion in optical characteristics.

Some embodiments provide a display device, including a display panel, a protecting film, and a second protecting film. In some embodiments, the first protecting film may be attached under the display panel, and the second protecting film may be attached on the second protecting film. Here, at least any one of the first and second protecting films includes a retardation layer.

In some embodiments, the display panel may have flexibility.

In some embodiments, the retardation layer may consist of one or more of triacetyl cellulose (TAC), cycloolefin polymer (COP), polymethyl methacrylate (PMMA), polycarbonate (PC), and polyethylene terephthalate (PET) in a single layer or multilayer.

In some embodiments, at least any one of the first and second protecting films may have a thickness of 20 to 120 μm.

In some embodiments, the display device may further include a touch panel formed on the second protecting film, a polarizing layer formed on the touch panel, and a window formed on the polarizing layer.

In some embodiments, the second protecting film and the touch panel may have an air gap therebetween.

In some embodiments, an edge of an upper portion of the second protecting film and an edge of a lower portion of the touch panel may be bonded to each other by a tape.

In some embodiments, the display device can have a simplified structure and minimize stress applied at the time of bending by using a protecting film having a thin thickness, superior mechanical strength, and no distortion in optical characteristics.

### BRIEF DESCRIPTION OF THE DRAWINGS

FIG. 1 is a cross-sectional view of a display device according to an embodiment.

FIG. 2 is a cross-sectional view of a display device according to another embodiment.

FIG. 3 to FIG. 9 are cross-sectional views showing first to sixth examples of a protecting film of each of the display devices shown in FIG. 1 and FIG. 2.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

The drawings and description are to be regarded as illustrative in nature and not restrictive Like reference numerals designate like elements throughout the specification.

Furthermore, as the size and thickness of the respective structural components shown in the drawings are arbitrarily illustrated for explanatory convenience, the present embodiments are not necessarily limited to the illustrated sizes and thicknesses.

In the drawings, the thickness of layers, films, panels, regions, etc., are exaggerated for clarity. In the drawings, for understanding and ease of description, the thicknesses of some layers and areas are exaggerated. It will be understood that when an element such as a layer, film, region, or substrate is referred to as being “on” another element, it may be “directly on” the other element or intervening elements may also be present.

In addition, unless explicitly described to the contrary, the word “comprise” and variations such as “comprises” or “comprising”, will be understood to imply the inclusion of stated elements but not the exclusion of any other elements. Further, in the specification, the word “on” means positioning on or below the object portion, but does not essentially mean positioning on the upper side of the object portion based on a gravity direction.

Hereinafter, a display device according to an embodiment of the present disclosure will be described in detail with reference to the accompanying drawings.

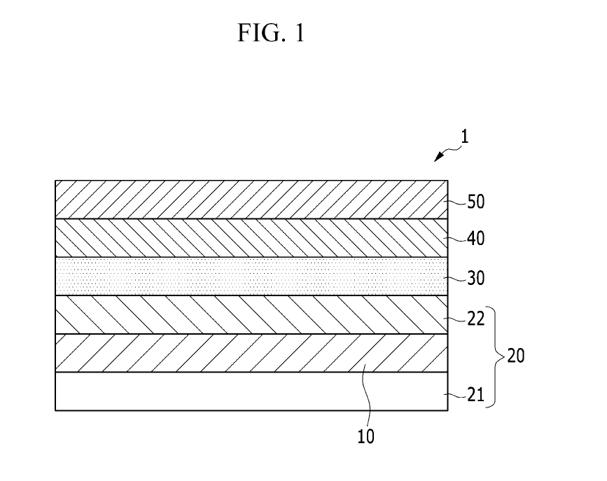

FIG. 1 is a cross-sectional view of a display device according to an embodiment.

Referring to FIG. 1, a display device according to an embodiment may include a display panel 10, a protecting film 20, a second protecting film 22, a touch panel 30, a polarizing layer 40, and a window 50, said protecting film 20 including a first protecting film 21, a second protecting film 22.

In some embodiments, the display panel 10, although not shown in the drawing, may include a substrate, light emitting elements formed on the substrate, and a thin film encapsulation layer covering the light emitting elements.

In some embodiments, the substrate may be formed of a polyimide (PI) layer, as a transparent material, and thus the display panel 10 may have flexibility.

As shown in FIG. 1, the first protecting film 21 is attached on a lower portion of the display panel 10, and the second protecting film 22 is attached on an upper portion of the display panel 10, that is, on the foregoing thin film encapsulation layer (not shown).

In some embodiments, the first and second protecting films 21 and 22 may serve to protect the display panel 10 in the process of manufacturing the display device 1.

In some embodiments, at least one of the first and second protecting films includes a retardation layer.

In some embodiments, a material having a retardation function, alone or in a multilayer, is included in the protecting film 20, so that the protecting film 20 is capable of performing both a protection function and a retardation function.

Examples of the material having a retardation function may include triacetyl cellulose (TAC), cycloolefin polymer (COP), polymethyl methacrylate (PMMA), polycarbonate (PC), polyethylene terephthalate (PET), and the like.

Here, polyethylene terephthalate (PET) is relatively difficult to use as a sole component due to photo-elasticity thereof, and thus it may be used together with another material having the foregoing retardation function in a multilayer.

In some embodiments, the retardation layer may be included in only the second protecting film 22 located on the upper portion of the display panel 10, or may be included in both the first and second protecting films 21 and 22 located on the lower and upper portions of the display panel 10.

In some embodiments, the first protecting film 21 or the first and second protecting films 21 and 22 including the retardation layer as described above may be formed by an extruding process without a stretching process.

In some embodiments, the first and second protecting films may be formed to have a thin thickness of, for example, about 20 to 120 μm.

In an embodiments, as shown in FIG. 1, the touch panel 30 for touch sensing may be formed on the second protecting film 22.

In some embodiments, the touch panel 30, although not shown in the drawing, may be a resistive type touch panel or a capacitive type touch panel.

In some embodiments, the resistive type touch panel may consist of upper and lower plates coated with a conductive material capable of receiving a signal by a pressure.

Further, as for the resistive type touch panel, a film having transparent electrodes is formed on a display module and a voltage is applied to each edge or corner of the film to generate a uniform electric field, so that, when any one point is touched through an input unit such as a pen or a finger, a voltage drop occurs and thus a position coordinate may be found.

In some aspects, as shown in FIG. 1, the polarizing plate 40 may be formed on the touch panel 30.

In some embodiments, the polarizing plate 40 may include a polarizer layer and upper and lower supporters supporting the polarizer layer (not shown in FIG. 1).

In some embodiments, the polarizer layer may be formed of polyvinyl alcohol (PVA), and the upper and lower supporters may be formed of triactyl cellulose (TAC).

Typically, a retardation layer is included in the lower portion of the polarizing layer and thus the polarizing layer may perform both a polarization function and a retardation function. However, in the present embodiments, the retardation layer is separated from the polarizing layer and thus applied to the second protecting film 22, or both the first and second protecting films 21 and 22, respectively.

In some embodiments, the second protecting film 22 or the first and second protecting films 21 and 22 may perform both a function as a protecting film and the retardation function.

In an aspect, as shown in FIG. 1, the window 50 may be formed on the polarizing layer 40.

In some embodiments, the window 50, which serves to protect the display panel 30, may be formed of a transparent material such as glass, acryl, or the like.

As for an upper structure of the display device according to an embodiment, FIG. 1 shows the window 50, the polarizing layer 40, and the touch panel 30, which are stacked in the shown order. However, this order may be partially changed. For example, the window 50, the touch panel 30, and the polarizing layer 40 may be stacked as recited herein.

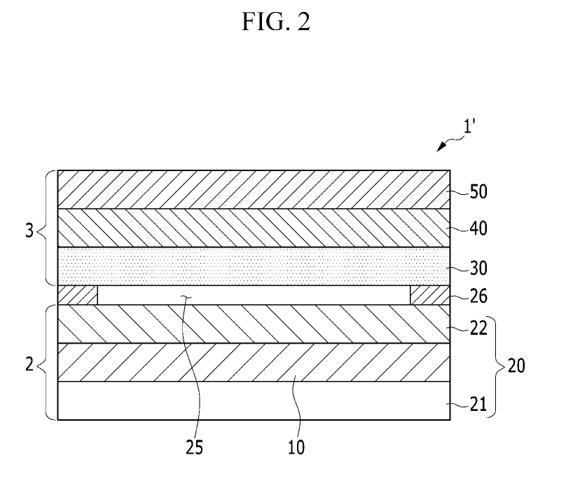

FIG. 2 is a cross-sectional view of a display device 1′ according to another embodiment.

Referring to FIG. 2, the display device 1′ according to another embodiment may include a display panel 10, a first protecting film 21, a second protecting film 22, a touch panel 30, a polarizing layer 40, and a window 50. In some embodiments, the second protecting film 22 and the touch panel 30 may be spaced apart from each other at a predetermined distance.

Here, in describing the display device according to the embodiment shown in FIG. 2, each component that is the same as that of the embodiment shown in FIG. 2 is designated by the same numeral, and descriptions of the component having the same numeral is omitted.

In some embodiments, as shown in FIG. 2, the edge of an upper portion of the second protecting film 22 and the edge of a lower portion of the touch panel 30 may be bonded by a bonding tape 26, to thereby form an air gap 25 between the second protecting film 22 and the touch panel 30.

This structure has an advantage in that an upper structure body and a lower structure body are separately manufactured, and then later coupled with each other centering on the air gap 25.

In some embodiments, a retardation layer may be included in the second protecting film 22 or both the first and second protecting films 21 and 22, thereby solving the problem that a refractive index of air is different from a refractive index of the protecting film.

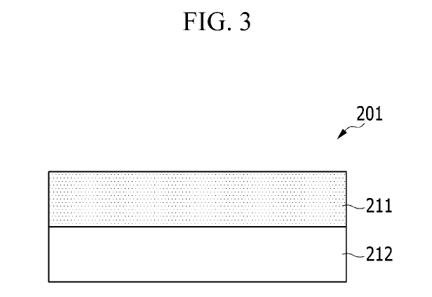

FIG. 3 to FIG. 9 are cross-sectional views showing first to sixth examples of the protecting film 20 of each of the display devices 1 and 1′ shown in FIG. 1 and FIG. 2.

As described above, each of the examples of the protecting film 20 may be applied to only the second protecting film 22, or both the first and second protecting films 21 and 22.

In some embodiments, the protecting film of each of the display devices 1 and 1′ shown in FIG. 1 and FIG. 2, shown in FIG. 3 as protecting film 201, may consist of layer 211 consisting of cycloolefin polymer (COP) and polymethyl methacrylate layer 212 consisting of polymethyl methacrylate (PMMA) in the order shown. In some embodiments, at least one of the layers may be a retardation layer.

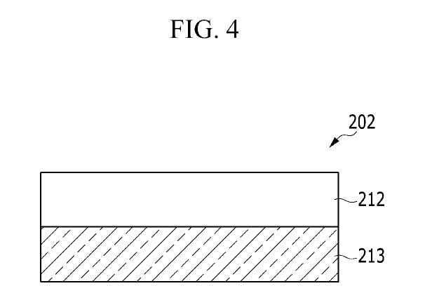

In some embodiments, the protecting film of each of the display devices 1 and 1′ shown in FIG. 1 and FIG. 2, shown in FIG. 4 as protecting film 202, may consist of layer 212 consisting of polymethyl methacrylate (PMMA) and layer 213 consisting of polycarbonate in the shown order. In some embodiments, at least one of the layers may be a retardation layer.

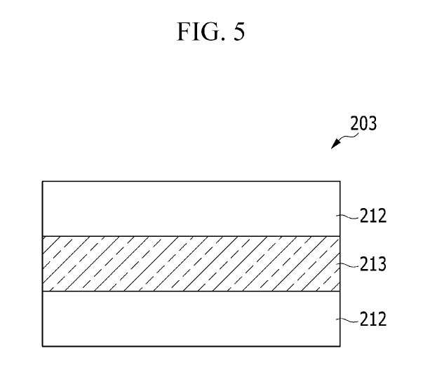

In some embodiments, the protecting film of each of the display devices 1 and 1′ shown in FIG. 1 and FIG. 2, shown in FIG. 5 as protecting film 203, may consist of layer 212 consisting of polymethyl methacrylate (PMMA), layer 213 consisting of polycarbonate (PC), and layer 212 consisting of polymethyl methacrylate (PMMA) in the shown order. In some embodiments, at least one of the layers may be a retardation layer.

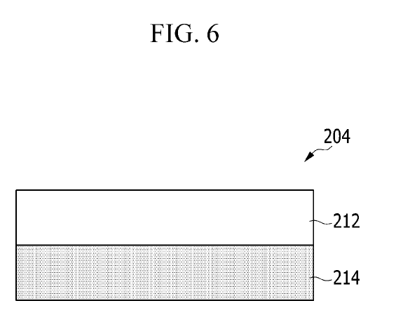

In some embodiments, the protecting film of each of the display devices 1 and 1′ shown in FIG. 1 and FIG. 2, shown in FIG. 6 as protecting film 204, may consist of layer 212 consisting of polymethyl methacrylate (PMMA) and layer 214 consisting of injection molded-polymethyl methacrylate in the shown order. In some embodiments, at least one of the layers may be a retardation layer.

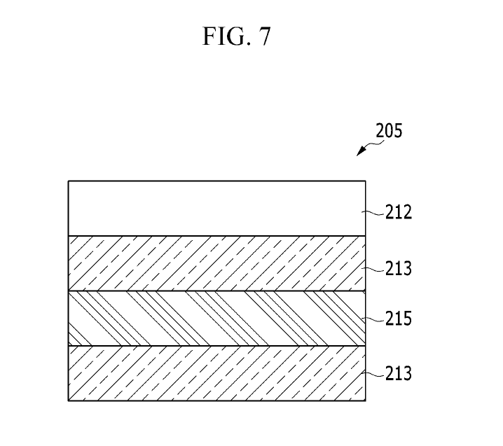

In some embodiments, the protecting film of each of the display devices 1 and 1′ shown in FIG. 1 and FIG. 2, shown in FIG. 7 as protecting film 205, may consist of layer 212 consisting of polymethyl methacrylate (PMMA), layer 213 consisting of polycarbonate (PC), layer 215 consisting of polyethylene terephthalate (PET), and layer 213 consisting of polycarbonate (PC) in the shown order. In some embodiments, at least one of the layers may be a retardation layer.

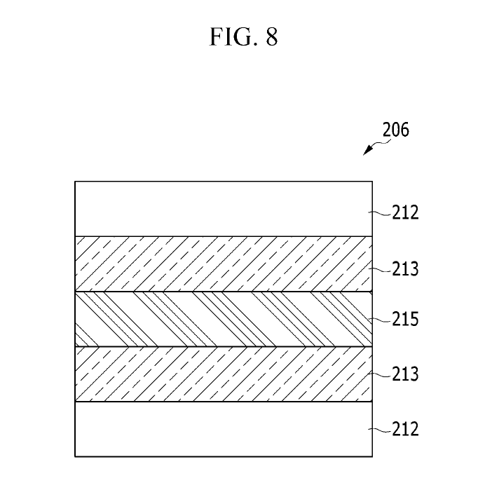

In some embodiments, the protecting film of each of the display devices 1 and 1′ shown in FIG. 1 and FIG. 2, shown in FIG. 8 as protecting film 206, may consist of layer 212 consisting of polymethyl methacrylate (PMMA), layer 213 consisting of polycarbonate (PC), layer 215 consisting of polyethylene terephthalate (PET), layer 213 consisting of polycarbonate (PC), and layer 212 consisting of polymethyl methacrylate (PMMA) in the shown order. In some embodiments, at least one of the layers may be a retardation layer.

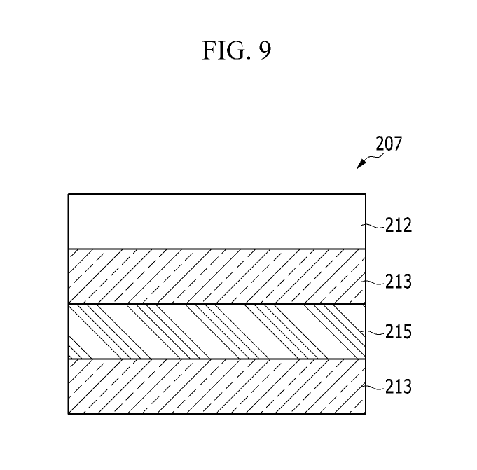

In some embodiments, the protecting film of each of the display devices 1 and 1′ shown in FIG. 1 and FIG. 2, shown in FIG. 9 as protecting film 207, may consist of 212 consisting of polymethyl methacrylate (PMMA), 213 consisting of polycarbonate (PC), 215 polyethylene terephthalate (PET) , and 213 consisting of polycarbonate (PC) in the shown order. In some embodiments, at least one of the layers may be a retardation layer.

Besides the foregoing embodiments, the design thereof may be changed to have a material having a retardation function, alone or in a multilayer, so that the stress applied at the time of bending can be minimized.

Particularly, the protecting film formed in a multilayer can obtain superior mechanical strength.

According to the present disclosure, a display device having a simple structure and minimizing stress applied at the time of bending can be provided by using the protecting film having a thin thickness, superior mechanical strength, and no distortion in optical characteristics.

While this disclosure has been described in connection with what is presently considered to be practical exemplary embodiments, it is to be understood that the disclosure is not limited to the disclosed embodiments and is intended to cover various modifications and equivalent arrangements included within the spirit and scope of the appended claims.

What is claimed is:

1. A display device, comprising:
a display panel; and
a protecting film, said protecting film comprising a first protecting film attached under the display panel, and
a second protecting film attached on the second protecting film,
wherein at least any one of the first and second protecting films includes a retardation layer.

2. The display device of claim 1, wherein the display panel has flexibility.

3. The display device of claim 1, wherein the retardation layer consists of one or more of triacetyl cellulose (TAC), cycloolefin polymer (COP), polymethyl methacrylate (PMMA), polycarbonate (PC), and polyethylene terephthalate (PET) as a single layer or multilayer.

4. The display device of claim 1, wherein at least any one of the first and second protecting films has a thickness of 20 to 120 μm.

5. The display device of claim 1, further comprising:
a touch panel formed on the second protecting film;
a polarizing layer formed on the touch panel; and
a window formed on the polarizing layer.

6. The display device of claim 5, wherein the second protecting film and the touch panel have an air gap therebetween.

7. The display device of claim 6, wherein an edge of an upper portion of the second protecting film and an edge of a lower portion of the touch panel are bonded to each other by a tape.

8. The display device of claim 1, wherein the first protecting film comprises a retardation layer.

9. The display device of claim 8, wherein the retardation layer consists of at least one of triacetyl cellulose (TAC), cycloolefin polymer (COP), polymethyl methacrylate (PMMA), polycarbonate (PC), and polyethylene terephthalate (PET).

10. The display device of claim 1, wherein the second protecting film comprises a retardation layer.

11. The display device of claim 10, wherein the retardation layer consists of at least one of triacetyl cellulose (TAC), cycloolefin polymer (COP), polymethyl methacrylate (PMMA), polycarbonate (PC), and polyethylene terephthalate (PET).

12. The display device of claim 1, wherein the first protecting film comprises a first retardation layer and the second protecting film comprises a second retardation layer.

13. The display device of claim 12, wherein the first retardation layer consists of at least one of triacetyl cellulose (TAC), cycloolefin polymer (COP), polymethyl methacrylate (PMMA), polycarbonate (PC), and polyethylene terephthalate (PET).

14. The display device of claim 12, wherein the second retardation layer consists of at least one of triacetyl cellulose (TAC), cycloolefin polymer (COP), polymethyl methacrylate (PMMA), polycarbonate (PC), and polyethylene terephthalate (PET).
